(19) United States
(12) Patent Application Publication
(10) Pub. No.: US 2026/0179824 A1
(43) Pub. Date: Jun. 25, 2026

(54) COIL COMPONENT

(71) Applicant: SAMSUNG ELECTRO-MECHANICS CO., LTD., Suwon-si (KR)

(72) Inventors: Boum Seock KIM, Suwon-si (KR); Ju Hwan YANG, Suwon-si (KR); Jae Hun KIM, Suwon-si (KR); Sang Jin KIM, Suwon-si (KR)

(73) Assignee: SAMSUNG ELECTRO-MECHANICS CO., LTD., Suwon-si (KR)

(21) Appl. No.: 19/346,991

(22) Filed: Oct. 1, 2025

(30) Foreign Application Priority Data
Dec. 20, 2024 (KR) 10-2024-0193242

(51) Int. Cl. H01F 27/28

(52) U.S. Cl. CPC H01F 27/2804

(57) ABSTRACT

A coil component includes a body containing a magnetic material, a support member disposed in the body, and a coil disposed on the support member. One surface of the support member has a roughness, and a side surface of the coil has a roughness. A maximum height roughness (Rmax_s) of the support member surface is greater than a maximum height roughness (Rmax_c) of the coil side surface, thereby improving adhesion between the coil and the support member while enabling fine patterning of the coil.

### CROSS-REFERENCE TO RELATED APPLICATION(S)

This application claims the benefit of priority to Korean Patent Application No. 10-2024-0193242 filed on Dec. 20, 2024 with the Korean Intellectual Property Office, the disclosure of which is incorporated herein by reference in its entirety.

### TECHNICAL FIELD

The present disclosure relates to a coil component.

An inductor, a coil component, may be a representative passive electronic component used in electronic devices, along with a resistor and a capacitor.

With the advancement of IT technologies, a reduction in size and thickness of various electronic devices has been accelerating, and accordingly, thin-film inductors used in such electronic devices have also been required to have a reduced size and thickness.

As power inductors have a reduced thickness, research and development has been conducted to increase the number of turns of the coil pattern (fine patterning) and to increase a height of a coil pattern in order to achieve a reduction in size of a product without loss of chip properties such as inductance and Rdc.

As a coil pattern becomes finer, adhesion between the coil pattern and a substrate may decrease, which may lead to coil lifting defects.

### SUMMARY

An aspect of the present disclosure is to provide a coil component capable of achieving fine patterning of a coil pattern while securing adhesion to a support member.

According to an aspect of the present disclosure, there is provided a coil component including a body including a magnetic material, a support member disposed in the body, the support member having a roughness formed on one surface thereof, and a coil disposed on the one surface of the support member, the coil having a roughness formed on a side surface thereof. A maximum height roughness (Rmax_s) of the one surface of the support member having the roughness formed thereon may be greater than a maximum height roughness (Rmax_c) of the side surface of the coil having the roughness formed thereon.

According to another aspect of the present disclosure, there is provided a coil component including a body including a magnetic material, a support member disposed in the body, the support member having a roughness formed on one surface thereof, and a coil disposed on the one surface of the support member, the coil having a roughness formed on a side surface thereof. A maximum height roughness (Rmax_c) of the side surface of the coil having the roughness formed thereon may have a value of 10 nm or more and 100 nm or less.

According to the present disclosure, a coil component may achieve fine patterning of a coil pattern while securing adhesion to a support member.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic view of a coil component according to an example embodiment of the present disclosure;

FIG. 2 is a cross-sectional view taken along line I-I′ of FIG. 1;

FIG. 3 is a cross-sectional view taken along line II-II′ of FIG. 1;

FIG. 4 is an enlarged view of portion “A” of FIG. 2; and

FIG. 5A to FIG. 5G show the manufacturing process of a coil component according to the present disclosure.

### DETAILED DESCRIPTION

The terms used herein are for the purpose of describing particular example embodiments only and are not to be limiting of the example embodiments. As used herein, the singular forms “a,” “an,” and “the” are intended to include the plural forms as well, unless the context clearly indicates otherwise. As used herein, the term “and/or” includes any one and any combination of any two or more of the associated listed items. It will be further understood that the terms “comprises” and/or “comprising,” when used in this disclosure, specify the presence of stated features, integers, steps, operations, elements, components or a combination thereof, but do not preclude the presence or addition of one or more other features, integers, steps, operations, elements, components, and/or groups thereof. In addition, the terms “disposed on,” “positioned on,” and the like, may mean that an element is positioned on or below a target portion, and may not necessarily mean that the element is positioned on an upper side of the target portion with respect to a direction of gravity.

The terms “coupled to,” “connected to,” and the like, may not only indicate that elements are directly and physically in contact with each other, but also include a configuration in which another element is interposed between the elements such that the elements are also in contact with the other element.

The size and thickness of each element illustrated in the drawings are arbitrarily represented for ease of the description, but the present disclosure is not limited to those illustrated herein.

In the drawings, an X-direction may be defined as a first direction or a length direction, a Y-direction may be defined as a second direction or a width direction, and a Z-direction may be defined as a third direction or a thickness direction.

Hereinafter, a coil component according to an example embodiment of the present disclosure will be described in detail with reference to the accompanying drawings. In the description with reference to the accompanying drawings, the same or corresponding elements are denoted by the same reference numerals and repeated descriptions thereof will be omitted.

Various types of electronic components may be used in electronic devices, and various types of coil components may be appropriately used between such electronic components to remove noise.

That is, in an electronic device, a coil component may be used as a power inductor, a high frequency (HF) inductor, a general bead, a high-frequency bead (GHz bead), a common mode filter, or the like.

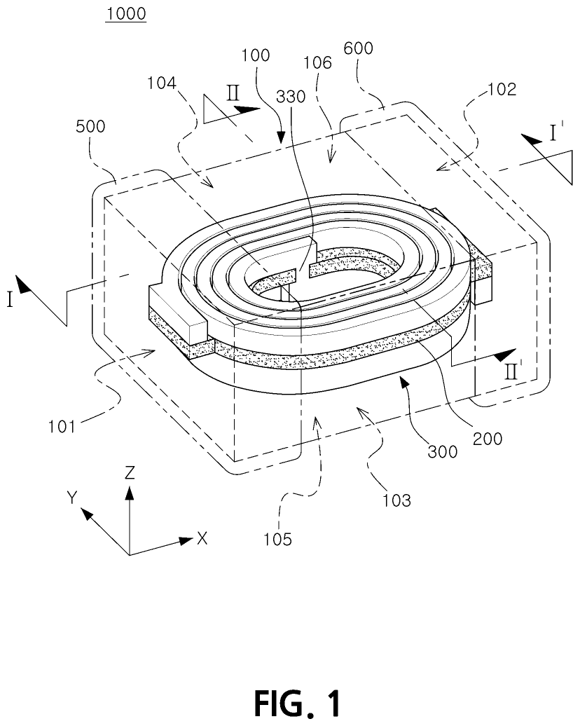

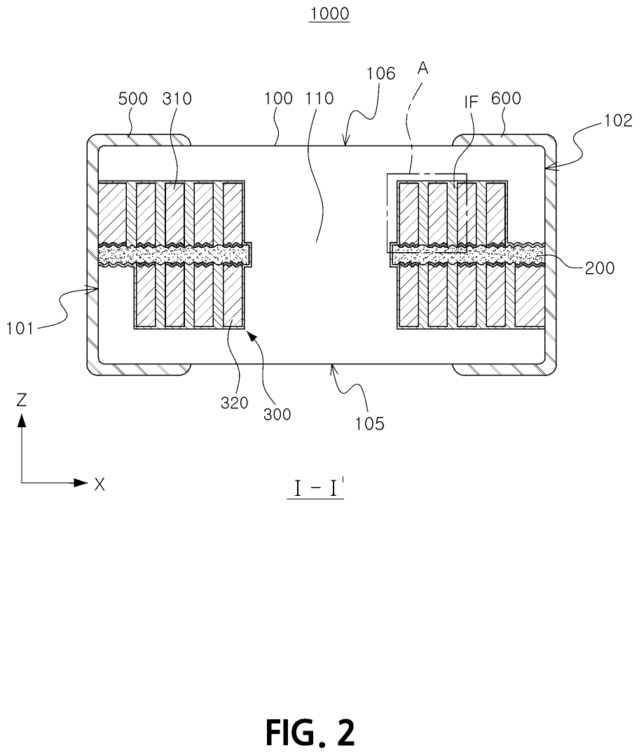

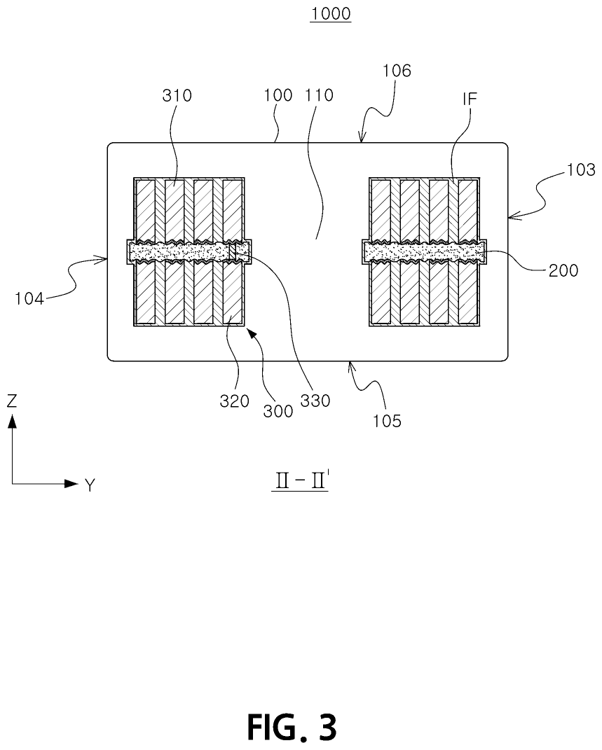

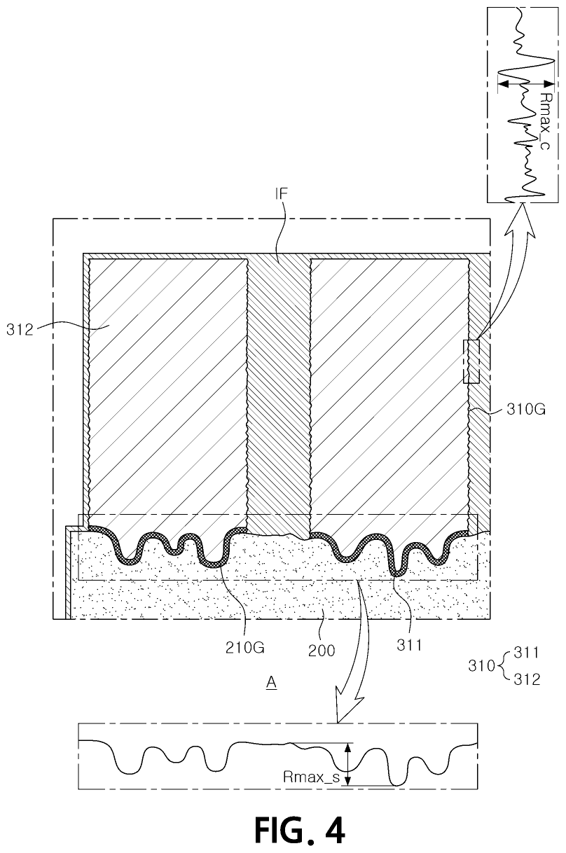

FIG. 1 is a schematic view of a coil component according to an example embodiment of the present disclosure. FIG. 2 is a cross-sectional view taken along line I-I′ of FIG. 1. FIG. 3 is a cross-sectional view taken along line II-II′ of FIG. 1. FIG. 4 is an enlarged view of portion “A” of FIG. 2.

Referring to FIGS. 1 to 4, a coil component 1000 according to an example embodiment of the present disclosure may include a body 100, a support member 200, and a coil 300, and may further include an insulating film IF and external electrodes 500 and 600.

The body 100 may form an overall exterior of the coil component 1000 according to the present example embodiment, and may include the support member 200 and the coil 300 embedded therein.

The body 100 may have an overall hexahedral shape.

Referring to FIGS. 1 to 3, the body 100 may include a first surface 101 and a second surface 102 opposing each other in a length direction X, a third surface 103 and a fourth surface 104 opposing each other in a width direction Y, and a fifth surface 105 and a sixth surface 106 opposing each other in a thickness direction Z. Each of the first to fourth surfaces 101, 102, 103, and 104 of the body 100 may correspond to a side surface of the body 100 connecting the fifth surface 105 and the sixth surface 106 to each other.

The body 100 may be formed such that the coil component 1000 according to the present example embodiment, in which the external electrodes 500 and 600 to be described below are formed, may have a length of 0.8 mm, a width of 0.65 mm, and a thickness of 0.45 mm, but the present disclosure is not limited thereto. The above-described sizes of the coil component 1000 are merely exemplary, and a case in which the coil component 1000 has a size other than the above-described sizes is not excluded from the scope of the present disclosure.

The body 100 may include a magnetic material and a resin. Specifically, the body 100 may be formed by laminating one or more magnetic composite sheets including a resin and magnetic powder particles dispersed in the resin, and then curing the magnetic composite sheets. However, the body 100 may have a structure other than a structure in which the magnetic powder particles are dispersed in the resin. For example, the body 100 may be formed of a magnetic material such as ferrite.

The magnetic material may be, for example, ferrite powder particles or metal magnetic powder particles.

The ferrite powder particles may be, for example, at least one of spinel-type ferrite powder particles such as Mg—Zn-based ferrite powder particles, Mn—Zn-based ferrite powder particles, Mn—Mg-based ferrite powder particles, Cu—Zn-based ferrite powder particles, Mg—Mn—Sr-based ferrite powder particles, Ni—Zn-based ferrite powder particles, or the like, hexagonal ferrite powder particles such as Ba—Zn-based ferrite powder particles, Ba—Mg-based ferrite powder particles, Ba—Ni-based ferrite powder particles, Ba—Co-based ferrite powder particles, Ba—Ni—Co-based ferrite powder particles, or the like, garnet-type ferrite powder particles such as Y-based ferrite powder particles or the like, or Li-based ferrite powder particles.

The magnetic metal powder particles may include one or more selected from the group consisting of iron (Fe), silicon (Si), chromium (Cr), cobalt (Co), molybdenum (Mo), aluminum (Al), niobium (Nb), copper (Cu), and nickel (Ni). For example, the magnetic metal powder particles may be at least one of pure iron powder particles, Fe—Si-based alloy powder particles, Fe—Si—Al-based alloy powder particles, Fe—Ni-based alloy powder particles, Fe—Ni—Mo-based alloy powder particles, Fe—Ni—Mo—Cu-based alloy powder particles, Fe—Co-based alloy powder particles, Fe—Ni—Co-based alloy powder particles, Fe—Cr-based alloy powder particles, Fe—Cr—Si-based alloy powder particles, Fe—Si—Cu—Nb-based alloy powder particles, Fe—Ni—Cr-based alloy powder particles, or Fe—Cr—Al-based alloy powder particles.

The magnetic metal powder particles may be amorphous or crystalline. For example, the magnetic metal powder particles may be Fe—Si—B—Cr-based amorphous alloy powder particles, but the present disclosure is not limited thereto.

Each of the ferrite powder particles and the magnetic metal powder particles may have an average diameter of about 0.1 μm to about 30 μm, but the present disclosure is not limited thereto.

The body 100 may include two or more types of magnetic powder particles dispersed in the resin. Here, different types of magnetic powder particles may mean that the magnetic powder particles are distinguished from each other in terms of one of an average diameter, a composition, crystallinity, and a shape. For example, the body 100 may include two or more types of magnetic powder particles having different particle diameters.

The resin may include epoxy, polyimide, a liquid crystal polymer, or the like alone or in combination, but the present disclosure is not limited thereto.

The body 100 may include a core 110 passing through the support member 200 and the coil 300 to be described below. During a process of laminating and curing magnetic composite sheets, the core 110 may be formed by filling a through-hole of the coil 300 with at least a portion of the magnetic composite sheets, but the present disclosure is not limited thereto.

The support member 200 may have one surface and the other surface, and may be embedded in the body 100, together with the coil 300 to be described below. The support member 200 may be configured to support the coil 300. In the present example embodiment, for ease of description, the one surface of the support member 200 is described, but the present disclosure is not limited thereto. The description of the one surface of the support member 200 may be equally applied to the other surface of the support member 200.

The support member 200 may be formed of an insulating material including a thermosetting insulating resin such as an epoxy resin, a thermoplastic insulating resin such as polyimide, or a photosensitive insulating resin, or an insulating material in which a reinforcing material, such as a glass fiber or an inorganic filler, is impregnated into the above-described insulating resins. For example, the support member 200 may be formed of an insulating material such as a copper clad laminate (CCL), a prepreg, an Ajinomoto build-up film (ABF), FR-4, a bismaleimide triazine (BT) film, a photoimageable dielectric (PID) film, or the like, but the present disclosure is not limited thereto.

At least one selected from the group consisting of silica (SiO₂), alumina (Al₂O₃), silicon carbide (SiC), barium sulfate (BaSO₄), talc, clay, mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), and calcium zirconate (CaZrO₃) may be used as the inorganic filler.

When the support member 200 is formed of an insulating material including a reinforcing material, the support member 200 may provide more excellent rigidity. When the support member 200 is formed of an insulating material not including a glass fiber, the support member 200 may be advantageous in reducing an overall thickness of the coil 300. When the support member 200 is formed of an insulating material including a photosensitive insulating resin, the number of processes for forming the coil 300 may be reduced, which may be advantageous in reducing production costs, and a fine via may be formed.

Referring to FIGS. 2 to 4, the support member 200 may have a roughness 210G formed on one surface thereof. A maximum height roughness (Rmax_s) of the one surface of the support member 200 having the roughness formed thereon may be 1 μm or more and 7.5 μm or less. As a coil pattern becomes finer, adhesion between the coil pattern and a substrate may be reduced, and a defect such as coil lifting may occur. Accordingly, in the coil component according to the present example embodiment, the support member 200 may have a roughness such that the maximum height roughness (Rmax_s) is 1 μm or more or 7.5 μm or less, such that adhesion between the coil and the support member may be secured.

When the maximum height roughness (Rmax_s) is less than 1 μm, adhesion between the support member 200 and the coil 300 may be reduced. When the maximum height roughness (Rmax_s) is greater than 7.5 μm, the support member 200 may have degraded rigidity, which may be disadvantageous for forming the coil 300 having a high aspect ratio.

The roughness 210G of the support member of the coil component according to the present example embodiment may be formed by performing plasma treatment on the support member 200. Specifically, in a state in which the coil 300 is not yet formed, surface etching may be performed on the one surface of the support member 200 using plasma, and the roughness 210G may be formed on the one surface of the support member 200.

As will be described below, a roughness 310G may be formed on a side surface of the coil 300, and the maximum height roughness (Rmax_s) of the one surface of the support member having the roughness 210G formed thereon may be greater than a maximum height roughness (Rmax_c) of the side surface of the coil having the roughness 310G thereon.

A thickness of the support member 200 may be 10 μm or more and 20 μm or less. When the thickness of the support member 200 is 10 μm or less, it may be difficult to secure rigidity of the support member 200, and thus it may be difficult to support the coil 300 to be described below during the manufacturing process. When the thickness of the support member 200 is 20 μm or more, it may be disadvantageous for reducing a thickness of the coil component, and a volume occupied by the support member 200 within a body having the same volume may increase, which may be disadvantageous for implementing a high inductance.

The coil 300 may be disposed on the one surface of the support member 200, and may form a plurality of turns to exhibit properties of the coil component. For example, when the coil component 1000 according to the present example embodiment is used as a power inductor, the coil 300 may serve to stabilize power of an electronic device by storing an electric field as a magnetic field and maintaining an output voltage.

The coil 300 may include a first coil pattern 310 disposed on the one surface of the support member 200, and a second coil pattern 320 disposed on the other surface of the support member 200. Hereinafter, the description will be provided based on the first coil pattern 310.

Referring to FIG. 4, the first coil pattern 310 may be disposed on the one surface of the support member 200 having the roughness 210G formed thereon. Due to the roughness 210G on the one surface of the support member 200, adhesion between the coil pattern 310 and the support member 200 may be secured.

Referring to FIG. 4, the roughness 310G may be formed on a side surface of the first coil pattern 310. A maximum height roughness (Rmax_c) of the side surface of the coil 300 having the roughness 310G formed thereon may have a value of 10 nm or more and 100 nm or less. As will be described below, a plating layer 312 may be formed by using an opening of an insulating wall as a plating growth guide. Etching may be performed on a partition pattern of the insulating wall, such that a roughness may be formed on a side surface of the insulating wall. The roughness of the side surface of the insulating wall may be transferred to the side surface of the first coil pattern 310, such that the roughness 310G may be formed on the side surface of the first coil pattern 310.

A roughness may not be formed on an upper surface of the first coil pattern 310. The upper surface of the first coil pattern 310 may not be in contact with a side surface of the insulating wall 420, such that the roughness may not be transferred. Accordingly, a maximum height roughness of the upper surface of the first coil pattern 310 may be less than 10 nm.

When the roughness 310G is formed on the side surface of the coil 300, adhesion with the insulating film IF of the coil may be improved. Specifically, the insulating film IF for insulation from the body 100 may be disposed on a surface of the coil 300, and the insulating film IF may include a generally used insulating material such as parylene, but an embodiment thereof is not limited thereto. The insulating film IF may be formed by a method such as vapor deposition, but an embodiment thereof is not limited thereto, and the insulating film IF may be formed by laminating insulating films. Table 1 below may indicate results of measuring adhesion to an insulating film according to changes in the maximum height roughness (Rmax_c) of the side surface of the coil. Referring to Table 1, when the maximum height roughness (Rmax_c) of the side surface of the coil is 10 nm or more, adhesion to the insulating film may increase, and stable insulation performance may be secured.

TABLE 1

| Maximum Height | | | |
|---|---|---|---|
| Roughness | | | |
| (Rmax_c) of | | | |
| Side Surface | Adhesion | Rate of | Improvement |
| of Coil | (Mpa) | Change | in Adhesion |
| 0 | 20 | — | NG |
| 10 | 20.02 | 0.1% | OK |
| 20 | 20.04 | 0.2% | OK |
| 30 | 20.06 | 0.3% | OK |
| 40 | 20.08 | 0.4% | OK |
| 50 | 20.1 | 0.5% | OK |
| 60 | 20.12 | 0.6% | OK |
| 70 | 20.14 | 0.7% | OK |
| 80 | 20.16 | 0.8% | OK |
| 90 | 20.18 | 0.9% | OK |
| 100 | 20.2 | 1.0% | OK |
| 110 | 20.22 | 1.1% | OK |
| 120 | 20.24 | 1.2% | OK |

When the side surface of the coil 300 has an excessively large maximum height roughness (Rmax_c), resistance may increase due to an increase in surface area of the coil, which may degrade component properties. [Table 2] below may indicate results of measuring coil resistance according to changes in the maximum height roughness (Rmax_c) of the side surface of the coil. Referring to [Table 2], when the maximum height roughness (Rmax_c) of the side surface of the coil is greater than 100 nm, resistance may increase by more than 10%, as compared to a comparative example in which a roughness is not formed, and thus component properties (Rdc) may be degraded.

TABLE 2

| Maximum Height | | | |
|---|---|---|---|
| Roughness | | | |
| (Rmax_c) of | | | |
| Side Surface | Resistance | Rate of | Rdc |
| of Coil | (mΩ) | Change | margin |
| 0 | 350 | — | OK |
| 10 | 353.5 | 1.0% | OK |
| 20 | 357 | 2.0% | OK |
| 30 | 360.5 | 3.0% | OK |
| 40 | 364 | 4.0% | OK |
| 50 | 367.5 | 5.0% | OK |
| 60 | 371 | 6.0% | OK |
| 70 | 374.5 | 7.0% | OK |
| 80 | 378 | 8.0% | OK |
| 90 | 381.5 | 9.0% | OK |
| 100 | 385 | 10.0% | OK |
| 110 | 388.5 | 11.0% | NG |
| 120 | 392 | 12.0% | NG |

A distance between adjacent turns of the coil 300 may be 3 μm or more and 10 μm or less. As will be described below, the plating layer 312 may be formed by using an opening of an insulating wall as a plating growth guide, and a distance between coils may be adjusted by reducing a width of the insulating wall.

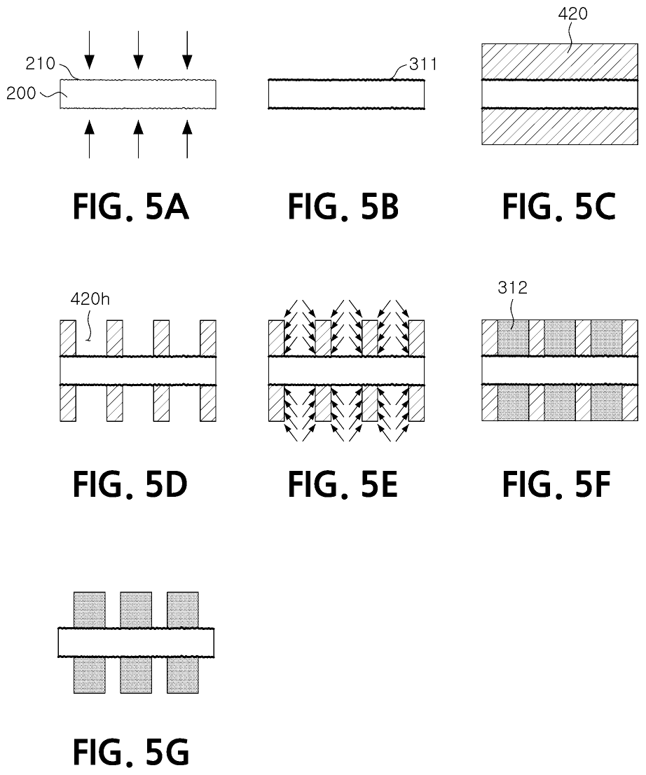

The coil component 1000 according to the present example embodiment may perform plasma treatment to reduce a size of the partition wall when the plating layer 312 using a partition wall method. In a partition wall method according to the related art, a width of a partition wall may have a minimum value 10 μm, and there is a limitation in reducing a line width to have a value equal to or less than the above-described value. However, in the present example embodiment, etching may be performed on a partition wall pattern using a plasma method, a width of the partition wall may be reduced, and accordingly a distance between adjacent turns of the coil may be reduced. Even when the partition wall is reduced in size, adhesion between the partition wall on which plasma treatment is performed and the support member 200 may be increased, thereby enabling stable coil formation. In addition, residue of a partition wall material may remain in a coil formation region (420h in FIG. 5), but unnecessary residue on the support member 200 may be removed through plasma treatment, thereby enabling stable coil formation.

As described above, the maximum height roughness (Rmax_s) of the support member having the roughness 210G formed thereon may be greater than the maximum height roughness (Rmax_c) of the side surface of the coil having the roughness 310G formed thereon.

The maximum height and the maximum height roughness of the support member of the coil component or the side surface of the coil according to the present example embodiment may be measured using the following method.

The maximum height roughness (Rmax_s) of the roughness 210G may be measured by preparing an X-Z cross-sectional sample passing through the center of the body and observing the sample using a scanning electron microscope (SEM). The maximum height is obtained as the greatest peak-to-valley value from the cross-sectional roughness profile in the sampled portion. Specifically, the maximum height roughness (Rmax_s) may be obtained by measuring a vertical distance between two parallel lines passing through a highest point and a lowest point of the roughness curve within a reference length of the sampled portion.

The maximum height roughness (Rmax_c) of the roughness 310G may be measured by preparing an X-Z cross-sectional sample passing through the center of the body, laying down the coil, and observing the sample using an atomic force microscope (AFM). The maximum height roughness (Rmax_c) of the roughness 310G at a side surface of the coil may be determined as a vertical distance between two parallel lines passing through the highest and lowest points of a roughness curve within a reference length of the sampled portion.

The maximum height roughness may also be measured using an optical surface profiler or a surface roughness tester, and may refer to an arithmetic mean of values obtained from a plurality of measurements.

The first coil pattern 310 may include a seed layer 311 disposed on the support member 200 and a plating layer 312 disposed on the seed layer. That is, the coil 300 of the present example embodiment may be a thin-film type coil formed using a plating method.

The seed layer 311 may be formed using a thin film process such as sputtering or the like, or an electroless plating process. The seed layer 311 may include at least one of copper (Cu), aluminum (Al), silver (Ag), tin (Sn), gold (Au), nickel (Ni), lead (Pb), titanium (Ti), chromium (Cr), molybdenum (Mo), or alloys thereof, and may be formed as at least one layer.

The plating layer 312 may be formed by performing electroplating using the seed layer 311 as a seed, and may include at least one of copper (Cu), aluminum (Al), silver (Ag), tin (Sn), gold (Au), nickel (Ni), platinum (Pt), titanium (Ti), chromium (Cr), and alloys thereof, and may be formed as at least one layer.

The coil 300 may include first and second coil patterns 310 and 320 and a via 330. In the directions of FIGS. 1, 2, and 3, the first coil pattern 310 may be disposed on one surface of the support member 200 opposing the sixth surface 106 of the body 100, and the second coil pattern 320 may be disposed on the other surface opposing the one surface of the support member 200.

Referring to FIGS. 1 to 3, the via 330 may pass through the support member 200 to be in contact with each of the first coil pattern 310 disposed on the one surface of the support member 200, and the second coil pattern 320 disposed on the other surface of the support member 200. Accordingly, the coil 300 may function as a single coil in which one or more turns are formed around the core 110.

The via 330 may include at least one plating layer. For example, when the via 330 is formed by electroplating, the via 330 may include a seed layer formed on an inner wall of a via hole passing through the support member 200, and an electroplating layer filling the via hole in which the seed layer is formed. The seed layer of the via 330 and the seed layer for forming the coil 300 may be formed together in the same process to be integrally formed with each other, or may be formed in different processes, such that boundaries therebetween may be formed. The via 330 may include a conductive material such as copper (Cu), aluminum (Al), silver (Ag), tin (Sn), gold (Au), nickel (Ni), lead (Pb), titanium (Ti), chromium (Cr), molybdenum (Mo), or alloys thereof.

An end of the coil 300 may be connected to first and second external electrodes 500 and 600 to be described below. Referring to FIGS. 1 and 2, an end of the first coil pattern 310 may be exposed to the first surface 101 of the body 100 and connected to the first external electrode 500, and an end of the second coil pattern 320 may be exposed to the second surface 102 of the body 100 and connected to the second external electrode 600.

The first and second external electrodes 500 and 600 may be disposed on the first and second surfaces 101 and 102 of the body 100, respectively. The first external electrode 500 may be disposed on the first surface 101 of the body 100 and connected to the end of the first coil pattern 310. The second external electrode 600 may be disposed on the second surface 102 of the body 100 and connected to the end of the second coil pattern 320.

The first and second external electrodes 500 and 600 may have a structure including a single layer structure or a plurality of layers. For example, the first external electrode 500 may include a first layer including copper (Cu), a second layer disposed on the first layer, the second layer including nickel (Ni), and a third layer disposed on the second layer, the third layer including tin (Sn). Here, the first to third layers may be formed by plating, respectively, but the present disclosure is not limited thereto. As another example, the first external electrode 500 may include a resin electrode including conductive powder particles, such as silver (Ag), and a resin, and a nickel (Ni)/tin (Sn) plating layer formed on the resin electrode.

The first and second external electrodes 500 and 600 may be formed of a conductive material such as copper (Cu), aluminum (Al), silver (Ag), tin (Sn), gold (Au), nickel (Ni), lead (Pb), titanium (Ti), or alloys thereof, but the present disclosure is not limited thereto.

The insulating film IF may insulate between the coil 300 and the body 100. The insulating film IF may cover an external surface of the coil 300, thereby insulating the coil 300 from the body 100.

The insulating film IF may be formed in the form of a conformal film along the external surface of the coil 300. The insulating film IF may cover an upper surface of the coil, and may be disposed between a plurality of turns of the coil.

The insulating film IF may include a known insulating material such as parylene or the like, but the present disclosure is not limited thereto. As another example, the insulating film IF may include an insulating material such as an epoxy resin or the like, rather than parylene. The insulating film IF may be formed using a vapor deposition method, but the present disclosure is not limited thereto. As another example, the insulating film IF may be formed by laminating and curing an insulating film for forming the insulating film IF on both surfaces of the support member 200 on which the coil 300 is formed, and the insulating film IF may be formed by coating and curing an insulating paste for forming the insulating film IF on both surfaces of the support member 200 on which the coil 300 is formed.

In the present disclosure, the insulating film IF may be an optional element. When the body 100 is capable of securing sufficient electrical resistance under an operating condition of the coil component 1000 according to the present example embodiment, the insulating film IF may be omitted.

Hereinafter, an example method for manufacturing a coil component having the above-described structure will be described. FIGS. 5A to 5B are diagrams illustrating sequential processes for forming the coil component.

Referring to FIG. 5A, first, a support member 200 may be prepared, and plasma etching may be performed on one surface and the other surface of the support member 200 to form a roughness 210G. As described above, a maximum height roughness (Rmax_s) of the roughness 210G formed on the one surface of the support member 200 may be 1 μm or more and 7.5 μm or less. The roughness 210G may be formed on the support member 200, such that sufficient adhesion between the support member 200 and a coil may be secured. The support member 200 may be obtained by removing copper foil from a CCL according to the related art or the like, but the present disclosure is not limited thereto.

Referring to FIG. 5B, a seed layer 311 may be formed on the support member 200 having the roughness 210G. The seed layer 311 may be formed using a known method, for example, CVD, physical vapor deposition (PVD), sputtering, or the like, using a dry film, but the present disclosure is not limited thereto.

Referring to FIG. 5C, an insulating wall 420 may be formed on each of both surfaces of the support member 200. The insulating wall 420 may be a resist film, and may be formed by laminating a resist film and curing the resist film, or by coating and curing a resist film material, but the present disclosure is not limited thereto. The laminating method may include, for example, a method of performing hot pressing to press a resist film at a high temperature for a predetermined period of time, cooling the resist film to room temperature under reduced pressure, and subsequently performing cold pressing to cool the resist film and separate a work tool from the resist film. The coating method may include, for example, a screen-printing method using a squeegee to coat ink, and a spray-printing method in which ink is coated in an atomized state. To use a subsequent photolithography method, drying may be performed such that curing is not completed. The insulating wall 420 may include a photo imageable dielectric (PID) that may be stripped by a stripping solution. For example, the insulating wall 420 may include a photosensitive material including a cyclic ketone compound and an ether compound having a hydroxyl group as main components. In this case, the cyclic ketone compound may be cyclopentanone or the like, and the ether compound having a hydroxyl group may be polypropylene glycol monomethyl ether or the like. Alternatively, the insulating wall 420 may include a photosensitive material including a bisphenol-based epoxy resin as a main component. In this case, the bisphenol-based epoxy resin may be a bisphenol A novolac epoxy resin, a bisphenol A diglycidyl ether bisphenol A polymer resin, or the like. However, the present disclosure is not limited thereto.

Referring to FIG. 5D, an opening 420h having a planar coil shape may be formed in the insulating wall 420. The opening may be formed using a known photolithography method, that is, a known exposure and development method. The opening may be patterned sequentially or all at once. Exposure equipment and developing solution are not limited, and may be appropriately selected depending on a photosensitive material used.

Referring to FIG. 5E, plasma dry etching may be performed on the insulating wall 420 having the opening 420h. Through plasma treatment, a roughness may be formed on a side surface defining the opening 420h of the insulating wall 420. In a partition wall method according to the related art, a width of a partition wall of the insulating wall 420 may have a minimum value of 10 μm, and there is a limitation in reducing a line width to have a value equal to or less than the above-described value. However, in the present example embodiment, etching may be performed on a partition wall pattern using a plasma method, a width of the partition wall may be reduced, and accordingly a distance between adjacent turns of the coil may be reduced. Even when the partition wall is reduced in size, adhesion between the partition wall on which plasma treatment is performed and the support member 200 may be increased, thereby enabling stable coil formation. In addition, residue of a partition wall material may remain in a coil formation region (420h in FIG. 5), but unnecessary residue on the support member 200 may be removed through plasma treatment, thereby enabling stable coil formation.

Referring to FIG. 5F, a plating layer 312 may be formed on the seed layer 311 using the opening 420h of the insulating wall 420 as a plating growth guide. In this case, due to the roughness formed on the side surface of the insulating wall 420, a roughness 310G may be formed on a side surface of the coil 300. As described above, a maximum height roughness (Rmax_c) of the side surface of the coil 300 having the roughness 310G formed thereon may have a value of 10 nm or more and 100 nm or less. The plating method is not limited, and may include electroplating, electroless plating, or the like, but the present disclosure is not limited thereto.

Referring to FIG. 5G, after the coil 300 is formed, the insulating wall 420 may be removed. The insulating wall 420 may be removed using a known stripping solution or the like. After the insulating wall 420 is removed, the seed layer 311 may be etched to complete a coil pattern, and an insulating film IF may be selectively formed.

While example embodiments have been shown and described above, it will be apparent to those skilled in the art that modifications and variations could be made without departing from the scope of the present disclosure as defined by the appended claims.

What is claimed is:

1. A coil component comprising:
a body including a magnetic material;
a support member disposed in the body, the support member having a roughness formed on one surface thereof; and
a coil disposed on the one surface of the support member, the coil having a roughness formed on a side surface thereof,
wherein a maximum height roughness (Rmax_s) of the one surface of the support member is greater than a maximum height roughness (Rmax_c) of the side surface of the coil.

2. The coil component of claim 1, wherein the maximum height roughness (Rmax_s) of the one surface of the support member has a value of 1 μm or more and 7.5 μm or less.

3. The coil component of claim 1, wherein the maximum height roughness (Rmax_c) of the side surface of the coil has a value of 10 nm or more and 100 nm or less.

4. The coil component of claim 1, wherein the coil includes a seed layer disposed on the one surface of the support member, and a plating layer disposed on the seed layer.

5. The coil component of claim 1, wherein
the maximum height roughness (Rmax_c) of the side surface of the coil has a value of 10 nm or more and 100 nm or less, and
a maximum height roughness (Rmax_c) of an upper surface of the coil has a value less than 10 nm.

6. The coil component of claim 1, wherein the coil includes a plurality of turns.

7. The coil component of claim 6, wherein a distance between adjacent turns, among the plurality of turns, is 3 μm or more and 10 μm or less.

8. The coil component of claim 6, further comprising:
an insulating film disposed between the plurality of turns.

9. The coil component of claim 1, wherein
the support member includes another surface opposing the one surface, and
a roughness is formed on the other surface of the support member.

10. The coil component of claim 9, wherein the coil includes a first coil pattern disposed on the one surface of the support member, a second coil pattern disposed on the other surface of the support member, and a via passing through the support member, the via connecting the first and second coil patterns to each other.

11. The coil component of claim 1, wherein the support member is substantially free of resist residue at an interface with the coil.

12. A coil component comprising:
a body including a magnetic material;
a support member disposed in the body, the support member having a roughness formed on one surface thereof; and
a coil disposed on the one surface of the support member, the coil having a roughness formed on a side surface thereof,
wherein a maximum height roughness (Rmax_c) of the side surface of the coil has a value of 10 nm or more and 100 nm or less.

13. The coil component of claim 12, wherein a maximum height roughness (Rmax_s) of the one surface of the support member has a value of 1 μm or more and 7.5 μm or less.

14. The coil component of claim 12, wherein
the coil includes a plurality of turns, and
a distance between adjacent turns, among the plurality of turns, is 3 μm or more and 10 μm or less.

15. The coil component of claim 12, wherein
the support member includes another surface opposing the one surface, and
a roughness is formed on the other surface of the support member.

16. The coil component of claim 15, wherein
the coil includes a first coil pattern disposed on the one surface of the support member, a second coil pattern disposed on the other surface of the support member, and a via passing through the support member, the via connecting the first and second coil patterns to each other.

17. The coil component of claim 12, wherein the support member is substantially free of resist residue at an interface with the coil.
